(19) United States
(12) Patent Application Publication
(10) Pub. No.: US 2026/0149018 A1
(43) Pub. Date: May 28, 2026

(54) Apparatus And Method For Controlling Charging Of Vehicle

(71) Applicants: Hyundai Motor Company, Seoul (KR); Kia Corporation, Seoul (KR)

(72) Inventors: Soon Ho Kwon, Hwaseong-si (KR); Su Dong Han, Hwaseong-si (KR)

(21) Appl. No.: 19/177,788

(22) Filed: Apr. 14, 2025

(30) Foreign Application Priority Data
Sep. 20, 2024 (KR) 10-2024-0127502

(51) Int. Cl. H01M 8/04746; B60L 50/75; B60L 53/62; B60S 5/02; H01M 8/04082; H01M 8/04111; H01M 8/0432; H01M 8/0438; H01M 10/44; H01M 10/46; H01M 16/00

(52) U.S. Cl. CPC H01M 8/04753; B60L 50/75; B60L 53/62; B60S 5/02; H01M 8/04111; H01M 8/04201; H01M 8/04328; H01M 8/04388; H01M 8/04776; H01M 10/443; H01M 10/46; H01M 16/006; H01M 2220/20; H01M 2250/20; H01M 2250/402

(57) ABSTRACT

An apparatus for controlling charging of a vehicle is introduced. The apparatus may comprise an electricity charging device configured to charge a battery of the vehicle, a hydrogen charging device configured to supply a first portion of hydrogen received from a hydrogen supply device into a hydrogen tank of the vehicle under supply pressure of the hydrogen supply device. Based on pressure of the hydrogen tank exceeding the supply pressure of the hydrogen supply device, the hydrogen charging device may compress, using a hydrogen compressor, a second portion of hydrogen received from the hydrogen supply device and supply the compressed second portion of hydrogen into the hydrogen tank. A processor of the apparatus may be configured to receive charging information from the electricity charging device and the hydrogen charging device and output the charging information through an output device.

### CROSS-REFERENCE TO RELATED APPLICATION

This application claims the benefit of priority to Korean Patent Application No. 10-2024-0127502, filed in the Korean Intellectual Property Office on Sep. 20, 2024, the entire contents of which are incorporated herein by reference.

### TECHNICAL FIELD

The present disclosure relates to an apparatus and a method for controlling charging of a vehicle, and more particularly, relates to an apparatus and a method for controlling charging of vehicle, capable of simultaneously charging hydrogen and electricity.

### BACKGROUND

The matters described in this Background section are only for enhancement of understanding of the background of the disclosure, and should not be taken as acknowledgment that they correspond to prior art already known to those skilled in the art.

The development of a hydrogen-electricity hybrid vehicle is in progress to provide a power source required in vehicle driving, by mounting both a hydrogen fuel cell system and a battery pack. The hydrogen-electricity hybrid vehicle may be equipped with a power-train system using only a battery for vehicle driving, a power-train system using completely independently the battery and the fuel cell for vehicle driving, or a power-train system using both the battery and the fuel cell for vehicle driving.

Hydrogen may be injected into a vehicle for shorter than 5 minutes. However, since an ultra-low temperature and an ultra high pressure state need to be maintained to charge hydrogen, a waiting time to charge hydrogen is more prolonged. When a hydrogen station lacks compressed hydrogen, a waiting time to compress hydrogen may be added. Right after low-temperature hydrogen is charged, a charging gun may be frozen. In this case, waiting is additionally required until the charging gun is unfrozen, thereby significantly increasing the charging time.

### SUMMARY

The present disclosure has been made to solve the above-mentioned problems.

According to the present disclosure, an apparatus for controlling charging of a vehicle, the apparatus may comprise an electricity charging device configured to charge a battery of the vehicle, a hydrogen charging device configured to supply a first portion of hydrogen received from a hydrogen supply device into a hydrogen tank of the vehicle to charge the hydrogen tank under supply pressure of the hydrogen supply device, based on pressure of the hydrogen tank exceeding the supply pressure of the hydrogen supply device, compress, using a hydrogen compressor, a second portion of hydrogen received from the hydrogen supply device, and supply the compressed second portion of hydrogen into the hydrogen tank to charge the hydrogen tank, and a processor configured to receive charging information from the electricity charging device and the hydrogen charging device, and output, through an output device, the charging information.

The apparatus, wherein the hydrogen charging device is configured to receive the charging information, wherein the charging information may comprise an estimated charging time for fully charging the battery by the electricity charging device.

The apparatus, wherein the hydrogen charging device is configured to, based on an estimated charging time for fully charging the battery and the pressure of the hydrogen tank exceeding the supply pressure of the hydrogen supply device, determine target charging pressure for the hydrogen compressor, and charge the hydrogen tank under the target charging pressure.

The apparatus, wherein the hydrogen charging device is configured to determine the target charging pressure such that the hydrogen tank is charged to a preset upper pressure limit of the hydrogen tank within the estimated charging time, and control an operation of the hydrogen compressor to output hydrogen at the target charging pressure.

The apparatus, wherein the hydrogen charging device is configured to charge, via the compression by the hydrogen compressor, the hydrogen tank under the target charging pressure for the estimated charging time, and determine, based on the pressure of the hydrogen tank being equal to or greater than a preset upper pressure limit of the hydrogen tank, that charging of the hydrogen tank and charging of the battery are completed. The apparatus, wherein the processor is configured to control, based on charging of the hydrogen tank and charging of the battery being completed, the output device to output the charging information, wherein the charging information may comprise charging-completion information.

The apparatus, wherein the hydrogen charging device is configured to determine, based on the pressure of the hydrogen tank being less than a preset upper pressure limit of the hydrogen tank, whether a temperature of the hydrogen tank exceeds a preset upper temperature limit of the hydrogen tank.

The apparatus, wherein the hydrogen charging device is configured to, based on a determination that the temperature of the hydrogen tank exceeds the preset upper temperature limit, stop charging the hydrogen tank and wait before resuming the charging of the hydrogen tank until the temperature of the hydrogen tank drops to a threshold temperature, wherein the threshold temperature is set based on an external temperature of the vehicle.

The apparatus, wherein the hydrogen charging device is configured to, based on the pressure of the hydrogen tank being less than or equal to the supply pressure, supply, via a hydrogen charging port of the vehicle, the first portion of hydrogen received from the hydrogen supply device, wherein the first portion of hydrogen bypasses the hydrogen compressor.

The apparatus, wherein the hydrogen charging device is configured to, based on a temperature of the hydrogen tank exceeding a preset upper temperature limit of the hydrogen tank during the charging of the first portion of hydrogen or based on the pressure of the hydrogen tank exceeding the supply pressure, terminate a charging process that bypasses the hydrogen compressor.

According to the present disclosure, a method for controlling charging of a vehicle, the method may comprise charging, by an electricity charging device, a battery of the vehicle, supplying, by a hydrogen charging device, a first portion of hydrogen received from a hydrogen supply device into a hydrogen tank of the vehicle to charge the hydrogen tank under supply pressure of the hydrogen supply device, based on pressure of the hydrogen tank exceeding the supply pressure of the hydrogen supply device, compressing, using a hydrogen compressor, a second portion of hydrogen received from the hydrogen supply device, supplying the compressed second portion of hydrogen into the hydrogen tank to charge the hydrogen tank, receiving charging information from the electricity charging device and the hydrogen charging device, and outputting, through an output device, the charging information.

The method may further comprise receiving the charging information, wherein the charging information may comprise an estimated charging time for fully charging the battery by the electricity charging device.

The method may further comprise based on an estimated charging time for fully charging the battery and the pressure of the hydrogen tank exceeding the supply pressure of the hydrogen supply device, determining target charging pressure for the hydrogen compressor, and charging the hydrogen tank under the target charging pressure.

The method may further comprise determining, by the hydrogen charging device, the target charging pressure such that the hydrogen tank is charged to a preset upper pressure limit of the hydrogen tank within the estimated charging time, and controlling an operation of the hydrogen compressor to output the target charging pressure.

The method may further comprise charging, via the compression by the hydrogen compressor, the hydrogen tank under the target charging pressure for the estimated charging time, and determining, based on the pressure of the hydrogen tank being equal to or greater than a preset upper pressure limit of the hydrogen tank, that charging of the hydrogen tank and charging of the battery are completed.

The method may further comprise controlling, based on charging of the hydrogen tank and charging of the battery being completed, the output device to output the charging information, wherein the charging information may comprise charging-completion information.

The method may further comprise determining, based on the pressure of the hydrogen tank being less than a preset upper pressure limit of the hydrogen tank, whether a temperature of the hydrogen tank exceeds a preset upper temperature limit of the hydrogen tank.

The method may further comprise based on a determination that the temperature of the hydrogen tank exceeds the preset upper temperature limit, stopping charging the hydrogen tank and waiting before resuming the charging of the hydrogen tank until the temperature of the hydrogen tank drops to a threshold temperature, wherein the threshold temperature is set based on an external temperature of the vehicle.

The method may further comprise based on the pressure of the hydrogen tank being less than or equal to the supply pressure, supplying, via a hydrogen charging port of the vehicle, the first portion of hydrogen received from the hydrogen supply device, wherein the first portion of hydrogen bypasses the hydrogen compressor.

According to the present disclosure, an apparatus for controlling charging of a vehicle, the apparatus may comprise an electricity charging device configured to charge a battery of the vehicle, a hydrogen charging device configured to supply hydrogen received from a hydrogen supply device into a hydrogen tank of the vehicle to charge the hydrogen tank under supply pressure of the hydrogen supply device, and a processor configured to control the electricity charging device to charge the battery, and control the hydrogen charging device to charge the hydrogen tank until pressure of the hydrogen tank does not exceed the supply pressure of the hydrogen supply device.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of the configuration of an apparatus for controlling charging of a vehicle, according to an example of the present disclosure;

FIG. 2 shows an example of the configuration of an electricity charging device, according to an example of the present disclosure;

FIG. 3 shows an example of the configuration of a hydrogen charging device, according to an example of the present disclosure;

FIG. 4 shows an example of the operation of an apparatus for controlling charging of a vehicle, according to an example of the present disclosure.

FIG. 5 shows an example of an apparatus for controlling charging of a vehicle, according to an example of the present disclosure;

FIG. 6 shows an example of a method for controlling charging of a vehicle, according to an example of the present disclosure; and

FIG. 7 shows an example of a computing system to execute the method according to an example of the present disclosure.

### DETAILED DESCRIPTION

Hereinafter, some examples of the present disclosure will be described in detail with reference to accompanying drawings. In the following description, the same reference numerals will be assigned to the same components even though the components are shown in different drawings. In addition, in the following description, a detailed description of well-known features or functions will be ruled out in order not to unnecessarily obscure the gist of the present disclosure.

In the following description of components according to an example of the present disclosure, the terms ‘first’, ‘second’, ‘A’, ‘B’, ‘(a)’, and ‘(b)’ may be used. These terms are only used to distinguish one element from another element, but do not limit the corresponding elements irrespective of the order or priority of the corresponding elements. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hydrogen-electric hybrid vehicles may serve as a potential clean energy alternative, but challenges remain in charging efficiency and infrastructure costs. Hydrogen refueling is relatively fast (3-5 minutes), but the process may involve long wait times due to hydrogen compression delays and nozzle freezing caused by ultra-low temperature fueling.

On the other hand, electric vehicle (EV) charging may require significantly more time, ranging from approximately 30 minutes to several hours, depending on the charging method.

The present disclosures provide a hydrogen-electric simultaneous charging system, which may reduce waiting time and infrastructure complexity by enabling hydrogen and electric charging to occur in parallel. Instead of relying on large hydrogen storage buffer tanks, the system may use a hydrogen supply line with a small compressor, allowing hydrogen supply without compression and switching to compression-based charging when compression is desirable. Furthermore, the system may enable hydrogen refueling without ultra-low temperature cooling requirements (−40° C.), reducing operational costs and complexity.

The system may dynamically determine whether to transfer hydrogen to the tank without compression or with compression based on real-time pressure and temperature monitoring. The system may also synchronize hydrogen and electric charging so that both processes complete at approximately the same time, enhancing vehicle turnaround at fueling stations. Further, the system may be configured at existing EV charging stations, enabling hydrogen refueling without the need for expensive infrastructure upgrades.

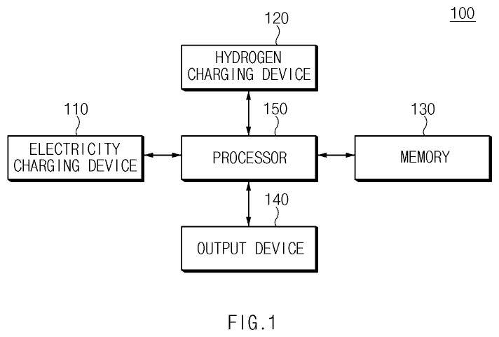

FIG. 1 shows an example of the configuration of an apparatus for controlling charging of a vehicle, according to an example of the present disclosure.

As shown in FIG. 1, an apparatus (hereinafter, a charging controlling device) 100 for controlling the charging of a vehicle according to an example of the present disclosure may include an electricity charging device 110, a hydrogen charging device 120, a memory 130, an output device 140, and a processor 150. According to the present disclosure, the charging controlling device 100 may include the electricity charging device 110 and the hydrogen charging device 120, thereby supplying power to the vehicle to charge a battery with the power while supplying hydrogen to be charged into a hydrogen tank (e.g., allowing simultaneous or sequential charging of both the battery and the hydrogen tank).

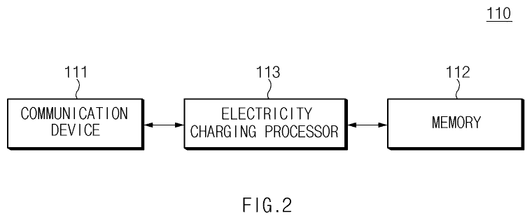

The electricity charging device 110 may supply power through an electricity charging port (e.g., charging interface) provided in the vehicle, to charge the battery provided in the vehicle. The details thereof will be described with reference to FIG. 2.

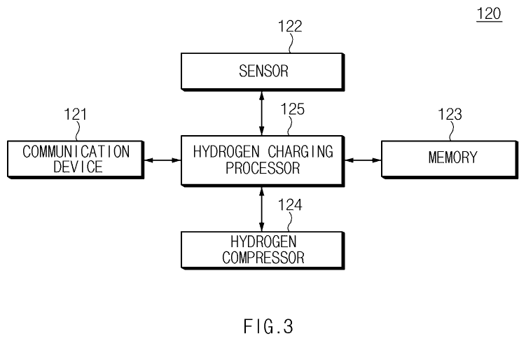

The hydrogen charging device 120 may supply hydrogen through a hydrogen charging port provided in the vehicle, to charge the hydrogen tank provided in the vehicle. The details thereof will be described with reference to FIG. 3.

The memory 130 may store at least one algorithm to compute or execute various instructions for the operation of the charging controlling device 100 of the vehicle, according to an example of the present disclosure. According to an example, the memory 130 may store at least one instruction executed by the processor 150, and the instruction may allow the charging controlling device 100 of the vehicle to operate according to an example. The memory 130 may include at least one storage medium of at least one a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, or an optical disc.

The output device 140 may output an image or a sound related to charging information (e.g., charging status updates, alerts, user notifications, etc.) under the control of the processor 150. According to an example, the output device 140 may be implemented using a display device or a sound output device. In this case, the display device may include a head up display (HUD) or cluster. According to an example, the display device may be implemented in the form of a display device employing a liquid crystal display (LCD) panel, a light emitting diode (LED) panel, an organic light emitting diode (OLED). The display device may be implemented in the form of a touch screen panel (TSP). When the display device may be implemented in the form of the touch screen panel (TSP), an interface may be provided together to input a user command.

The processor 150 may be implemented by various processing devices, such as a microprocessor embedded therein with a semiconductor chip (e.g., application-specific integrated circuit (ASIC), central processing unit (CPU), etc.) to operate or execute various instructions, and may control the charging controlling device 100 according to an example. The processor 150 may be electrically connected to the electricity charging device 110, the hydrogen charging device 120, the memory 130, and the output device 140 through a wired interface (e.g., cable), wireless interface, or various circuits to transmit an electrical signal including a control command to execute an arithmetic operation or data processing related to a control operation and/or communication. The processor 150 may include at least one of a central processing unit, an application processor, a communication processor (CP), or any combination thereof.

The processor 150 may receive charging information from the electricity charging device 110 and the hydrogen charging device 120 and may output the charging information through the output device 140.

According to an example, the processor 150 may output, through the output device 140, charging information including an estimated time (e.g., a charging-required time) for fully charging the battery through the electricity charging device 110. According to an example, the processor 150 may output, through the output device 140, charging information including a charging-completion information (e.g., an estimated time for full charge completion, power levels, hydrogen pressure levels, etc.) when hydrogen and electricity are completely charged.

FIG. 2 shows an example of the configuration of an electricity charging device, according to an example of the present disclosure.

As shown in FIG. 2, the electricity charging device 110 according to the present disclosure may include a communication interface (e.g., communication device 111), a memory 112, and an electricity charging processor 113.

The communication device 111 may include a transceiver, a communication circuit, and a communication processor to transmit or receive information using an antenna. The communication device 111 may make communication with the vehicle and the hydrogen charging device 120 through wired communication (e.g., landlines, Ethernet, USB, HDMI, Coaxial, Fiber optic, etc.) or wireless communication (e.g., Wi-Fi, Cellular networks, Bluetooth, Satellite communication, Infrared communication, Near-field communication, Radio Frequency identification, etc.). According to an example, the communication device 111 may receive, from the vehicle, the charging information (e.g., the estimated time to fully charge the battery, state of charge (SoC), charging power levels, voltage/current limits, etc.) and may transmit the charging information to the hydrogen charging device 120.

The memory 112 may store at least one algorithm to compute or execute various instructions for the operation of the electricity charging device 110 according to an example of the present disclosure. According to an example, the memory 112 may store at least one instruction executed by the electricity charging processor 113, and the instruction may allow the electricity charging device 110 to operate according to an example. The memory 112 may include at least one storage medium of at least one a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, or an optical disc.

The electricity charging processor 113 may be implemented by various processing devices, such as a microprocessor embedded therein with a semiconductor chip (e.g., application-specific integrated circuit (ASIC) to operate or execute various instructions, and may control the electricity charging device 110 according to an example. The electricity charging processor 113 may be electrically connected to the communication device 111 and the memory 112 through a wired interface (e.g., cable), a wireless interface, or various circuits to transmit an electrical signal including a control command to execute an arithmetic operation or data processing related to a control operation and/or communication. The electricity charging processor 113 may include at least one of a central processing unit, an application processor, a communication processor (CP), or any combination thereof.

The electricity charging processor 113 may output a message (e.g., user notifications, automated prompts, etc.) for providing a guidance for connecting a charging plug to the electricity charging port provided in the vehicle, when receiving an instruction related to supplying power to the vehicle, based on a user input. The electricity charging processor 113 may determine the estimated time to fully charge the battery by receiving a state of charge (SOC) of the battery from the vehicle, when the charging plug is connected to the charging port.

The electricity charging processor 113 may transmit the charging-required time to the hydrogen charging device 120, when the charging-required time is determined, for example, based on current charge state of a battery, expected energy consumption, or available power supply.

FIG. 3 shows an example of the configuration of a hydrogen charging device, according to an example of the present disclosure.

As shown in FIG. 3, the hydrogen charging device 120 may include a communication interface (e.g., communication device 121), a sensor 122, a memory 123, a hydrogen compressor 124, and a hydrogen charging processor 125.

The communication device 121 may include a transceiver, a communication circuit, and a communication processor to transmit or receive information using an antenna. The communication device 121 may make communication with the vehicle and the electricity charging device 110 through wired communication or wireless communication. According to an example, the communication device 121 may receive, from the vehicle, charging information (e.g., pressure and a temperature of the hydrogen tank provided in the vehicle, supply line flow rate, compressor efficiency metrics, etc.).

The sensor 122 may include multiple types of sensors (e.g., pressure, temperature, flow rate sensors) to monitor hydrogen supply conditions and ensure safe charging operations. Specifically, the sensor 122 may include a primary pressure sensor (e.g., a first pressure sensor) to sense supply pressure of hydrogen supplied from a hydrogen supply device (e.g., hydrogen inlet pressure from an external supply), and a secondary pressure sensor to sense supply pressure of hydrogen supplied from the hydrogen compressor 124 (e.g., internal tank pressure during hydrogen compression).

The memory 123 may store at least one algorithm to compute or execute various instructions for the operation of the hydrogen charging device 120, according to an example of the present disclosure. According to an example, the memory 123 may store at least one instruction executed by the hydrogen charging processor 125, and the instruction may allow the hydrogen charging device 120 to operate according to an example. The memory 123 may include at least one storage medium of at least one a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, or an optical disc.

The hydrogen compressor 124 may adjust the pressure of the hydrogen (e.g., compress the hydrogen), which is received from the hydrogen supply device, to store the hydrogen in the hydrogen tank provided in the vehicle.

The hydrogen charging processor 125 may be implemented by various processing devices, such as a microprocessor embedded therein with a semiconductor chip (e.g., application-specific integrated circuit (ASIC) to operate or execute various instructions, and may control the operation of the hydrogen charging device 120 according to an example. The hydrogen charging processor 125 may be electrically connected to the communication device 121, the sensor 122, the memory 123, and the hydrogen compressor 124 through a wired cable or various circuits to transmit an electrical signal including a control command to execute an arithmetic operation or data processing related to a control operation and/or communication. The hydrogen charging processor 125 may include at least one of a central processing unit, an application processor, a communication processor (CP), or any combination thereof.

The hydrogen charging processor 125 may perform a control operation to receive hydrogen from the hydrogen supply device, inject the hydrogen into the vehicle through the hydrogen charging port, and charge the hydrogen into the hydrogen tank provided in the vehicle. According to an example, the hydrogen supply device may include a hydrogen tube trailer.

According to an example, the hydrogen charging processor 125 may charge the hydrogen into the hydrogen tank under the supply pressure of the hydrogen supply device without compression, if the pressure of the hydrogen tank does not exceed a threshold pressure (e.g., the supply pressure of the hydrogen supply device). According to an example, the hydrogen charging processor 125 may terminate a charging process (e.g., charging of the hydrogen into the hydrogen tank under a threshold pressure), if the pressure of the hydrogen tank exceeds the threshold pressure (e.g., the supply pressure of the hydrogen supply device), or if the temperature of the hydrogen tank exceeds a threshold temperature (e.g., an upper temperature limit of the hydrogen tank) in the middle of charging the hydrogen tank under the threshold pressure (e.g., the supply pressure of the hydrogen supply device).

The hydrogen charging processor 125 may control an operation for compressing the hydrogen, which is supplied from the hydrogen supply device, through the hydrogen compressor to output high-pressure hydrogen compressed, and inject the compressed high-pressure hydrogen into the hydrogen tank through the hydrogen charging port to charge the hydrogen tank, if the pressure (charged pressure) of the hydrogen charged in the hydrogen tank exceeds the threshold pressure (e.g., the supply pressure of the hydrogen supplied from the hydrogen supply device).

The hydrogen charging processor 125 may receive the charging-required time estimated from the electricity charging device 110, when the power is supplied through the electricity charging device 110. In this case, the charging-required time may include time estimated to fully charge the battery provided in the vehicle.

According to an example, the hydrogen charging processor 125 may determine an average pressure ramp rate (APRR), at which hydrogen is compressed through the hydrogen compressor, for target charging pressure, based on charged pressure of the hydrogen tank, and the charging-required time received from the electricity charging device 110. In addition, the hydrogen charging processor 125 may charge the hydrogen tank by controlling the output of the hydrogen compressor based on the target charging pressure.

According to an example, the hydrogen charging processor 125 may determine the target charging pressure of the hydrogen compressor such that the hydrogen tank is charged from the charged pressure of the hydrogen tank to preset upper pressure limit of the hydrogen tank, for the charging-required time. According to an example, the hydrogen charging processor 125 may determine the target charging pressure based on Equation 1. The hydrogen charging processor 125 may complete the charging of the hydrogen tank and the charging of the battery at the same time, by charging the hydrogen tank, based on the target charging pressure calculated based on Equation 1.

Target charging pressure={(upper pressure limit of hydrogen tank)−(charged pressure of hydrogen tank)}/charging−required time Equation 1

For example, a target charging pressure would be 40 bar per minute when an upper pressure limit of hydrogen tank is 700 bar, an initial charged pressure of hydrogen tank is 300 bar, and charging required time is 10 minutes according to Equation 1: (700−300) bar/10 minutes=40 bar per minute.

The hydrogen charging processor 125 may determine whether the pressure of the hydrogen tank, which receives hydrogen compressed through the hydrogen compressor under the target charging pressure, is equal to or greater than the upper pressure limit or reference pressure preset by the user. This determination is to ensure safe charging and prevent over-pressurization of the hydrogen tank.

According to an example, the hydrogen charging processor 125 may determine the charging of the hydrogen tank and the charging of the battery as being completed, if the pressure of the hydrogen tank, which receives hydrogen compressed through the hydrogen compressor under the target charging pressure, is equal to or greater than the upper pressure limit or reference pressure preset by the user. In this case, the upper pressure limit of the hydrogen tank may be configured based on the specifications of the hydrogen tank (e.g., operational safety standards of the hydrogen tank). For example, if the hydrogen tank is designed to handle up to 700 bar, it may automatically stop charging if this limit is reached to avoid a hydrogen tank failure (e.g., rupture). The hydrogen charging processor 125 may determine the temperature of the hydrogen tank if the pressure of the hydrogen tank, which receives hydrogen compressed through the hydrogen compressor under the target charging pressure, is not equal to or not greater than the upper pressure limit or reference pressure preset by the user. For example, if the pressure of the hydrogen tank is less than 700 bar, the hydrogen charging processor 125 may determine the temperature of the hydrogen tank, for example, to prevent overheating of the hydrogen tank.

The hydrogen charging processor 125 may determine whether the temperature of the hydrogen tank exceeds the upper temperature limit of the hydrogen tank. The hydrogen charging processor 125 may determine that the hydrogen tank needs a cooling period to be cooled down before further charging, if the temperature of the hydrogen tank exceeds the upper temperature limit of the hydrogen tank. For example, if the upper temperature limit is set at 70° C. and the hydrogen tank temperature reaches 72° C. during charging, the hydrogen charging processor 125 may activate a cooling mode or temporarily suspend hydrogen compression.

The hydrogen charging processor 125 may stop and wait for charging until the temperature of the hydrogen tank reaches a safe temperature to resume the charging (e.g., a waiting (charging waiting) terminating temperature). The safe temperature may be determined based on an external environment conditions such as temperature of the vehicle (e.g., vehicle's ambient temperature) or vehicle's cooling capacity, if the temperature of the hydrogen tank exceeds the upper temperature limit of the hydrogen tank. For example, Table 1 shows the relationship between external vehicle temperature and the corresponding waiting terminating temperature of the hydrogen tank.

According to an example, the hydrogen charging processor 125 may set the waiting terminating temperature, based on the external temperature of the vehicle as shown in Table 1.

TABLE 1

| External vehicle | Waiting terminating |
|---|---|
| temperature (° C.) | temperature (° C.) |
| −30 | Hydrogen tank temperature −30 |
| −20 | Hydrogen tank temperature −28 |
| −10 | Hydrogen tank temperature −26 |
| 0 | Hydrogen tank temperature −24 |
| 10 | Hydrogen tank temperature −30 |
| 20 | Hydrogen tank temperature −30 |
| 30 | Hydrogen tank temperature −30 |
| 40 | Hydrogen tank temperature −30 |

According to an example, the hydrogen charging processor 125 may configure the waiting terminating temperature as 54° C. (adjusted from 70° C. to 24° C.), and stop and wait for the charging until the temperature of the hydrogen tank becomes 54° C., if the temperature of the hydrogen tank exceeds the upper temperature limit (e.g., 70° C.) and that the external temperature of the vehicle is 0° C. According to an example, the hydrogen charging processor 125 may reassess the pressure of the hydrogen tank if the temperature of the hydrogen tank is less than 54° C., and may determine a type of charging hydrogen based on the pressure of the hydrogen tank.

The hydrogen charging processor 125 may maintain the output of the hydrogen compressor to the target charging pressure, if the temperature of the hydrogen tank does not exceed the upper temperature limit.

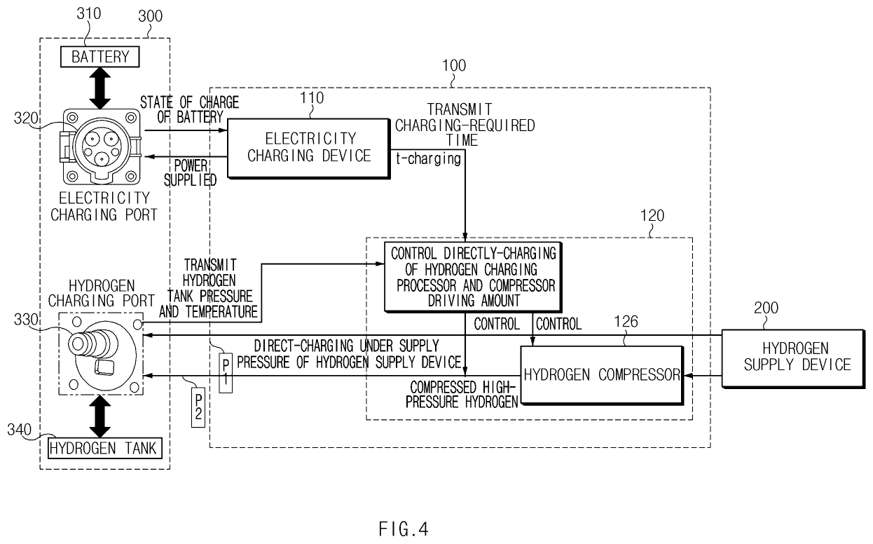

FIG. 4 shows an example of the operation of an apparatus for controlling charging of a vehicle, according to an example of the present disclosure.

As shown in FIG. 4, the charging controlling device 100 of the vehicle may include the electricity charging device 110 and the hydrogen charging device 120. The electricity charging device 110 and the hydrogen charging device 120 may make wired communication or wireless communication with a communication device (not shown) provided in a vehicle 300. According to an example, the electricity charging device 110 may receive charging information (e.g., a state of charge (SOC), a percentage of remaining battery capacity, etc.) about a battery provided in the vehicle 300, and the hydrogen charging device 120 may receive tank condition information (e.g., a pressure, a temperature, a pressure change, a temperature change, etc.) about the hydrogen tank provided in the vehicle 300.

The electricity charging device 110 may supply power to a battery 310 through an electric charging port 320 of the vehicle 300. The power supply may include alternating current (AC) to direct current (DC) conversion or fast-charging protocols such as CCS (Combined Charging System) for efficiency.

The electricity charging device 110 may receive the SOC of the battery 310 from the vehicle 300, may estimate the charging-required time for fully charging the battery 310, and may transmit the charging-required time to the hydrogen charging device 120.

The hydrogen charging device 120 may supply hydrogen to a hydrogen tank 340 through a hydrogen charging port 330 of the vehicle. According to an example, the hydrogen charging device 120 may charge the hydrogen tank 340 by supplying hydrogen in a first hydrogen charging scheme and/or a second hydrogen charging scheme. The choice of scheme may depend on the initial pressure of the hydrogen tank and the supply pressure from the hydrogen source.

According to an example, the first hydrogen charging scheme may include a scheme for charging the hydrogen tank 340 by supplying hydrogen from the hydrogen supply device 200 through the hydrogen charging port 330, under supply pressure P1 (e.g., outlet pressure of the hydrogen supply device 200 without additional compression of the hydrogen) of the hydrogen of the hydrogen supply device 200. For example, if P1 is greater than the initial tank pressure, rapid charging may be performed without compressing the hydrogen.

According to an example, the second hydrogen charging scheme may include a scheme for compressing the hydrogen, which is supplied from the hydrogen supply device 200, through a hydrogen compressor 126, and outputting the compressed hydrogen from the hydrogen compressor 126 to charge the hydrogen tank 340, if the pressure of the hydrogen tank 340 exceeds the supply pressure (e.g., pressure P1) of the hydrogen supplied from the hydrogen supply device 200. For example, if the supply pressure is 300 bar and the hydrogen tank already holds 320 bar, the hydrogen compressor may increase the pressure to a target charging pressure P2 (e.g., 600 bar) before delivering the hydrogen. According to an example, the second hydrogen charging scheme may include a scheme for compressing hydrogen to reach the target charging pressure P2 through the hydrogen compressor 126 and supplying the compressed hydrogen to charge the hydrogen tank 340. In this case, the target charging pressure may be determined based on the charging-required time received from the electricity charging device 110.

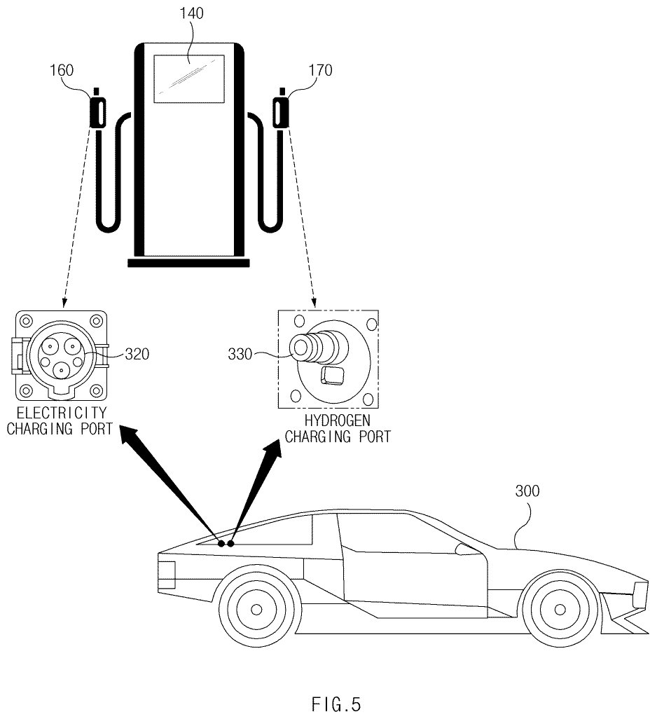

FIG. 5 shows an example of an apparatus for controlling charging of a vehicle, according to an example of the present disclosure.

As shown in FIG. 5, the charging controlling device 100 of the vehicle may include a first charging gun 160 to supply power to the electric charging port 320, and a second charging gun 170 to supply hydrogen to the hydrogen charging port 330. The charging controlling device 100 may also include an output device 140 to output information related to the charging. For example, the output device 140 may display real-time updates such as battery SOC, hydrogen tank pressure, and estimated charging time.

The vehicle 300 may include the electric charging port 320 coupled to the first charging gun 160 to receive power and the hydrogen charging port 330 coupled to the second charging gun 170 to receive hydrogen. The power received through the electric charging port 320 may be charged in the battery, and the hydrogen received through the hydrogen charging port 330 may be charged in the hydrogen tank. For example, the electric charging port 320 may utilize CCS (Combined Charging System) for fast charging, and the hydrogen charging port 330 may support high-pressure hydrogen refueling, for example, at 700 bar.

The vehicle 300 may control the driving by operating an electric motor using power charged in the battery or electricity generated from a fuel cell. The fuel cell is charged with the hydrogen stored in the hydrogen tank. The vehicle 300 may operate the electric motor solely using battery power or the fuel cell, or may operate the electric motor using the battery power and the fuel cell together. For instance, in hybrid operation, the vehicle 300 may prioritize battery power for short-range urban driving, while switching to the fuel cell for longer highway driving.

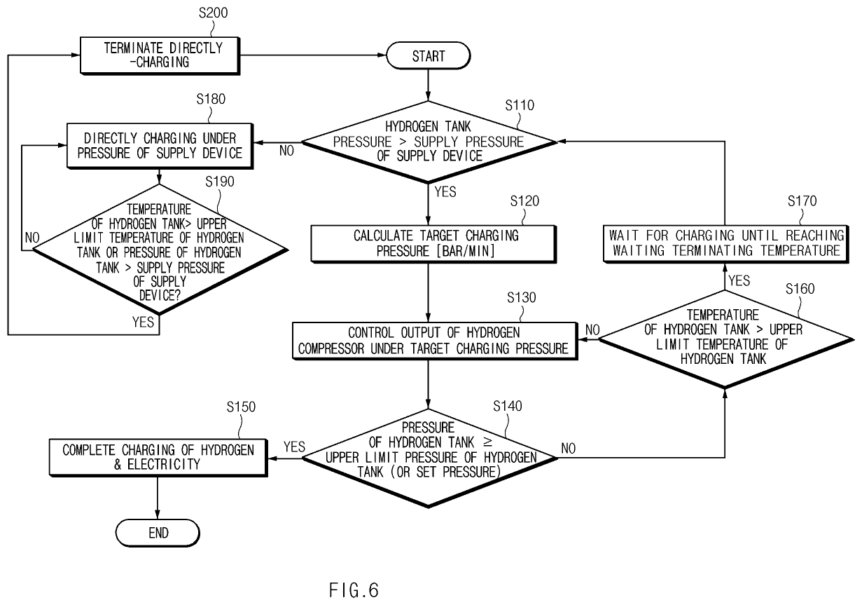

FIG. 6 shows an example of a method for controlling charging of a vehicle, according to an example of the present disclosure.

As shown in FIG. 6, the hydrogen charging device 120 may perform a control operation to receive hydrogen from the hydrogen supply device, inject the hydrogen into the vehicle through the hydrogen charging port of the vehicle, and charge or store the hydrogen into the hydrogen tank of the vehicle. According to an example, the hydrogen supply device may include a hydrogen tube trailer, on-site hydrogen generation station, hydrogen pipelines, or liquid hydrogen tankers.

The hydrogen charging device 120 may charge the hydrogen tank under the supply pressure of the hydrogen supply device, and may determine whether the pressure of the hydrogen tank exceeds the supply pressure of the hydrogen supply device (S110). If the hydrogen tank pressure is lower than the supply pressure, a bypass-charging mode may be used, bypassing the need for compression (e.g., the hydrogen bypasses the hydrogen compressor).

In S110, the hydrogen charging device 120 may control the operation for compressing the hydrogen, which is received from the hydrogen supply device, through the hydrogen compressor and outputting the compressed high-pressure hydrogen, if the pressure of the hydrogen tank (e.g., 320 bar) exceeds the supply pressure (e.g., 300 bar) of the hydrogen supply device, and may charge the hydrogen tank by injecting the compressed high-pressure hydrogen through the hydrogen charging port.

According to an example, the hydrogen charging device 120 may determine the target charging pressure of hydrogen which is output from the hydrogen compressor, based on the charging-required time received from the electricity charging device 110 (S120).

The hydrogen charging device 120 may receive the charging-required time determined, from the electricity charging device 110, when the power is supplied through the electricity charging device 110. In this case, the charging-required time may include time estimated for fully charging the battery provided in the vehicle.

According to an example, the hydrogen charging device 120 may determine an average pressure ramp rate (APRR), at which hydrogen is compressed through the hydrogen compressor, for target charging pressure. The determination is based on the charged pressure (e.g., initial pressure) of the hydrogen tank, and the charging-required time received from the electricity charging device 110. For example, if the hydrogen tank starts at 300 bar and must reach 700 bar in 10 minutes, the APRR is determined as 40 bar per minute.

According to an example, the hydrogen charging device 120 may determine the target charging pressure of the hydrogen compressor such that the hydrogen tank is charged from the charged pressure of the hydrogen tank to preset upper pressure limit of the hydrogen tank for the charging-required time. This may ensure that the hydrogen tank reaches an operational pressure without exceeding safety limits. According to an example, the hydrogen charging device 120 may determine the target charging pressure through Equation 1. For example, if the target charging pressure is 700 bar, the initial pressure of the hydrogen tank is 400 bar, and the time allowed is 15 minutes, Equation 1 would yield a target pressure ramp of 20 bar per minute.

The hydrogen charging device 120 may control the output of the hydrogen compressor to the target charging pressure (S130). The hydrogen charging device 120 may complete the charging of the hydrogen tank and the charging of the battery at the same time, by charging the hydrogen tank under the target charging pressure.

The hydrogen charging device 120 may determine whether the pressure of the hydrogen tank, which receives hydrogen compressed through the hydrogen compressor to the target charging pressure, is not equal to or greater than the upper pressure limit or reference pressure preset by the user (S140). This may ensure that the charging remains within the safe operational range of the hydrogen tank.

According to an example, the hydrogen charging device 120 may determine whether the charging of the hydrogen tank and the charging of the battery as being completed, if the pressure of the hydrogen tank, which is charged to the target charging pressure, is equal to or greater than the upper pressure limit of the hydrogen tank or reference pressure preset by the user in S140 (S150). In this case, the upper pressure limit of the hydrogen tank may be preset based on the specifications of the hydrogen tank. For instance, if the hydrogen tank's safety threshold is set to 700 bar, charging will stop automatically when this pressure is reached.

In S140, the hydrogen charging device 120 may determine the temperature of the hydrogen tank, if the pressure of the hydrogen tank, which receives hydrogen compressed through the hydrogen compressor under the target charging pressure, is not equal to or greater than the upper pressure limit or reference pressure preset by the user in S140. This determination may ensure the hydrogen tank does not overheat during extended charging sessions.

According to an example, the hydrogen charging device 120 may determine whether the temperature of the hydrogen tank exceeds the upper temperature limit of the hydrogen tank (S160).

The hydrogen charging device 120 may determine that the hydrogen tank needs to be cooled down, if the temperature of the hydrogen tank exceeds the upper temperature limit of the hydrogen tank in S160.

The hydrogen charging device 120 may stop and wait for charging until the temperature of the hydrogen tank reaches a safe temperature (e.g., a waiting (charging waiting) terminating temperature). The safe temperature may be preset based on an external temperature of the vehicle, if the temperature of the hydrogen tank exceeds the upper temperature limit of the hydrogen tank (S170).

According to an example, the hydrogen charging device 120 may set the waiting terminating temperature, based on the external temperature of the vehicle as shown in Table 1.

According to an example, the hydrogen charging device 120 may determine the safe temperature as 54° C. (adjusted from 70° C. to 24° C.), and may stop and wait for the charging until the temperature of the hydrogen tank becomes 54° C., if the temperature of the hydrogen tank exceeds the upper temperature limit (e.g., 70° C.) and the external temperature of the vehicle is 0° C. According to an example, the hydrogen charging device 120 may re-determine the pressure of the hydrogen tank if the temperature of the hydrogen tank is less than 54° C., may determine a type of charging hydrogen (e.g., bypass charging or compressed charging) based on the pressure of the hydrogen tank. The hydrogen charging device 120 may resume charging using the determined type of charging hydrogen.

The hydrogen charging device 120 may maintain the output of the hydrogen compressor to the target charging pressure, if the temperature of the hydrogen tank does not exceed the upper temperature limit in S160. This may ensure uninterrupted charging under safe temperature conditions.

In addition, the hydrogen charging device 120 may maintain the charging of the hydrogen tank under the supply pressure of the hydrogen supply device, if the pressure of the hydrogen tank does not exceed the supply pressure of the hydrogen supply device in S110 (S180). For example, bypass charging may be applied until the hydrogen tank pressure equals the supply pressure.

According to an example, the hydrogen charging device 120 may determine or monitor whether the pressure of the hydrogen tank exceeds the supply pressure of the hydrogen supply device, or the temperature of the hydrogen tank exceeds the upper temperature limit of the hydrogen tank in the middle of charging the hydrogen tank under the supply pressure of the hydrogen supply device (S190). This determination or monitoring may ensure safety and operational reliability of the charging process.

In S190, the hydrogen charging device 120 may maintain charging of the hydrogen tank under the supply pressure of the hydrogen supply device, if the pressure of the hydrogen tank does not exceed the supply pressure of the hydrogen supply device, or if the temperature of the hydrogen tank does not exceed the upper temperature limit of the hydrogen tank. This mode of operation may increase charging efficiency by bypassing unnecessary compression or interruptions when supply pressure suffices and the temperature is within a safe range.

The hydrogen charging device 120 may stop bypass charging of the hydrogen tank under the supply pressure of the hydrogen supply device, if the pressure of the hydrogen tank exceeds the supply pressure of the hydrogen supply device, or that the temperature of the hydrogen tank exceeds the upper temperature limit of the hydrogen tank in S190 (S200). For example, if the supply pressure from the hydrogen supply device is 300 bar but the hydrogen tank pressure increases beyond 300 bar (e.g., 400 bar), the hydrogen charging device 120 may automatically switch from bypass charging to compression-based charging via the hydrogen compressor. For example, if the hydrogen tank temperature rises beyond an upper temperature limit (e.g., 70° C.) due to a prolonged compression, charging may be suspended to allow a cooldown period.

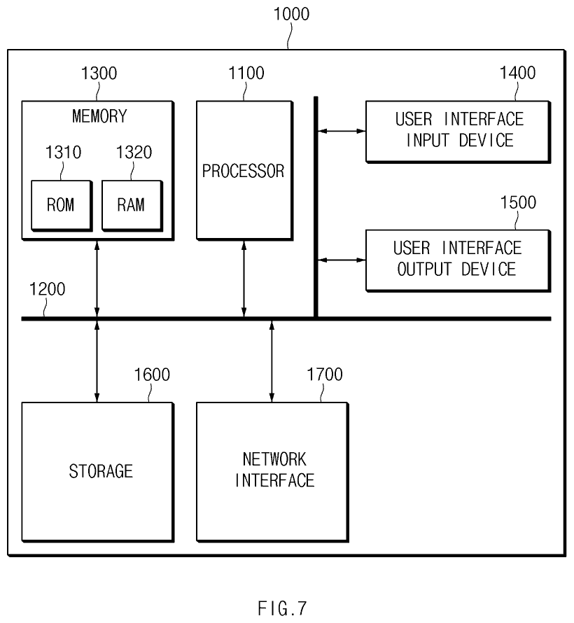

FIG. 7 shows an example of the configuration of an apparatus for controlling charging of a vehicle, according to an example of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the methods or algorithms described in connection with the examples disclosed in the present disclosure may be directly implemented with a hardware module, a software module, or any combination thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

An example of the present disclosure provides an apparatus and a method for controlling charging of a vehicle, capable of simultaneously charging hydrogen and electricity to facilitate the operation of a power-train system mounted in a hydrogen-electricity hybrid vehicle.

An example of the present disclosure provides an apparatus and a method for controlling charging of a vehicle, capable of charging hydrogen only using a supply line of hydrogen and a small-sized compressor without a large-sized hydrogen storage tank in a charging station, thereby saving costs required for hydrogen charging facilities.

An example of the present disclosure provides an apparatus and a method for controlling charging of a vehicle, capable of reducing costs by charging hydrogen without an ultra-low freezer, as room-temperature hydrogen in a gas phase is used.

An example of the present disclosure provides an apparatus and a method for controlling charging of a vehicle, capable of simultaneously charging hydrogen and electricity and making charging of hydrogen and charging of electricity finished at the same time, such that a user conveniently charges hydrogen and electricity.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an apparatus for controlling charging of a vehicle may include an electricity charging device to charge a battery provided in the vehicle, a hydrogen charging device to charge a hydrogen tank under supply pressure of a hydrogen supply device, compress hydrogen, which is supplied from the hydrogen supply device, through a hydrogen compressor, and supply the compressed hydrogen into the hydrogen tank to charge the hydrogen tank when pressure of the hydrogen tank exceeds the supply pressure of the hydrogen supply device, and a processor to receive charging information from the electricity charging device and the hydrogen charging device and output the charging information through an output device.

According to an example, the hydrogen charging device may receive a charging-required time required (e.g., a time estimated) to fully charge the battery from the electricity charging device.

According to an example, the hydrogen charging device may calculate target charging pressure output from the hydrogen compressor, based on the pressure of the hydrogen tank and a charging-required time required to fully charge the battery, when the pressure of the hydrogen tank exceeds the supply pressure hydrogen supplied from the hydrogen supply device, and charge the hydrogen tank under the target charging pressure.

According to an example, the hydrogen charging device may calculate the target charging pressure of the hydrogen compressor such that the hydrogen tank is charged to preset upper pressure limit of the hydrogen tank for the charging-required time, and control an operation to output the target charging pressure by the hydrogen compressor.

According to an example, the hydrogen charging device may charge the hydrogen tank under the target charging pressure for the charging-required time, and determine charging of hydrogen and charging of electricity as being completed, when the pressure of the hydrogen tank is determined as being equal to or greater than preset upper pressure limit of the hydrogen tank.

According to an example, the processor may control to output the charging information, which includes charging-completion information, through the output device, when charging of hydrogen and charging of electricity are completed.

According to an example, the hydrogen charging device may determine whether a temperature of the hydrogen tank exceeds a preset upper temperature limit of the hydrogen tank, when pressure of the hydrogen tank is less than preset upper pressure limit of the hydrogen tank.

According to an example, the hydrogen charging device may stop and wait for the charging until the temperature of the hydrogen tank becomes a waiting terminating temperature set based on an external temperature of the vehicle, when the temperature of the hydrogen tank is determined as exceeding the preset upper temperature limit of the hydrogen tank.

According to an example, the hydrogen charging device may receive hydrogen through a hydrogen charging port of the vehicle from the hydrogen supply device and charge the hydrogen tank, when the pressure of the hydrogen tank is less than or equal to the supply pressure supplied from the hydrogen supply device.

According to an example, the hydrogen charging device may terminate the charging when the temperature of the hydrogen tank is determined as exceeding preset upper temperature limit of the hydrogen tank through the charging, or when the pressure of the hydrogen tank exceeds the supply pressure.

According to an example of the present disclosure, a method for controlling charging of a vehicle may include charging, by an electricity charging device, a battery provided in the vehicle, charging, by a hydrogen charging device, a hydrogen tank under supply pressure of a hydrogen supply device, compressing, by the hydrogen charging device, hydrogen, which is supplied from the hydrogen supply device, through a hydrogen compressor, and supplying the compressed hydrogen into the hydrogen tank to charge the hydrogen tank, when pressure of the hydrogen tank exceeds the supply pressure of the hydrogen supply device, and receiving charging information from the electricity charging device and the hydrogen charging device and outputting the charging information through an output device.

According to an example, the method may further include receiving a charging-required time required for the hydrogen charging device to fully charge the battery from the electricity charging device.

According to an example, the method may further include calculating, by the hydrogen charging device, target charging pressure output from the hydrogen compressor, based on the pressure of the hydrogen tank and a charging-required time required to fully charge the battery, and charging the hydrogen tank under the target charging pressure, when the pressure of the hydrogen tank exceeds the supply pressure of hydrogen supplied from the hydrogen supply device.

According to an example, the method may further include calculating, by the hydrogen charging device, the target charging pressure of the hydrogen compressor such that the hydrogen tank is charged to preset upper pressure limit of the hydrogen tank for the charging-required time, and controlling an operation to output the target charging pressure by the hydrogen compressor.

According to an example, the method may further include charging, by the hydrogen charging device, the hydrogen tank under the target charging pressure for the charging-required time, and determining charging of hydrogen and charging of electricity as being completed, when the pressure of the hydrogen tank is determined as being equal to or greater than preset upper pressure limit of the hydrogen tank.

According to an example, the method may further include controlling to output the charging information, which includes charging-completion information, through the output device, when charging of hydrogen and charging of electricity are completed.

According to an example, the method may further include determining whether a temperature of the hydrogen tank exceeds a preset upper temperature limit of the hydrogen tank, when pressure of the hydrogen tank is less than preset upper pressure limit of the hydrogen tank.

According to an example, the method may further include stopping and waiting for, by the hydrogen charging device, the charging until the temperature of the hydrogen tank becomes a waiting terminating temperature set based on an external temperature of the vehicle, when the temperature of the hydrogen tank is determined as exceeding the preset upper temperature limit of the hydrogen tank.

According to an example, the method may further include receiving, by the hydrogen charging device, hydrogen through a hydrogen charging port of the vehicle from the hydrogen supply device and charging the hydrogen tank, when the pressure of the hydrogen tank is less than or equal to the supply pressure supplied from the hydrogen supply device.

According to an example, the method may further include terminating, by the hydrogen charging device, the charging, when the temperature of the hydrogen tank is determined as exceeding preset upper temperature limit of the hydrogen tank through the charging, or when the pressure of the hydrogen tank exceeds the supply pressure.

According to an example of the present disclosure, in the apparatus and the method for controlling the charging of the vehicle, hydrogen and electricity may be simultaneously charged to facilitate the operation of the power-train system provided in the hydrogen-electricity hybrid vehicle.

According to an example of the present disclosure, in the apparatus and the method for controlling the charging of the vehicle, hydrogen may be charged only using the supply line of hydrogen and the small-sized compressor without the large-sized hydrogen storage tank in the charging station, thereby saving costs required for hydrogen charging facilities.

According to an example of the present disclosure, in the apparatus and the method for controlling the charging of the vehicle, costs may be saved by charging hydrogen without the ultra-low freezer, as room-temperature hydrogen in a gas phase is used.

According to an example of the present disclosure, in the apparatus and the method for controlling the charging of the vehicle, the hydrogen and the electricity may be simultaneously charged, and the charging of hydrogen and the charging of electricity may be finished at the same time, such that a user conveniently charges hydrogen and electricity.

The above description is merely an example of the technical idea of the present disclosure, and various modifications and modifications may be made by one skilled in the art without departing from the essential characteristic of the present disclosure.

Therefore, the examples of the present disclosure are provided to explain the spirit and scope of the present disclosure, but not to limit them, so that the spirit and scope of the present disclosure is not limited by the examples. The scope of protection of the present disclosure should be construed by the attached claims, and all equivalents thereof should be construed as being included within the scope of the present disclosure.

What is claimed:

1. An apparatus for controlling charging of a vehicle, the apparatus comprising:
an electricity charging device configured to charge a battery of the vehicle;
a hydrogen charging device configured to:
supply a first portion of hydrogen received from a hydrogen supply device into a hydrogen tank of the vehicle to charge the hydrogen tank under supply pressure of the hydrogen supply device,
based on pressure of the hydrogen tank exceeding the supply pressure of the hydrogen supply device, compress, using a hydrogen compressor, a second portion of hydrogen received from the hydrogen supply device, and
supply the compressed second portion of hydrogen into the hydrogen tank to charge the hydrogen tank; and
a processor configured to:
receive charging information from the electricity charging device and the hydrogen charging device, and
output, through an output device, the charging information.

2. The apparatus of claim 1, wherein the hydrogen charging device is configured to:
receive the charging information, wherein the charging information comprises an estimated charging time for fully charging the battery by the electricity charging device.

3. The apparatus of claim 1, wherein the hydrogen charging device is configured to:
based on an estimated charging time for fully charging the battery and the pressure of the hydrogen tank exceeding the supply pressure of the hydrogen supply device, determine target charging pressure for the hydrogen compressor, and
charge the hydrogen tank under the target charging pressure.

4. The apparatus of claim 3, wherein the hydrogen charging device is configured to:
determine the target charging pressure such that the hydrogen tank is charged to a preset upper pressure limit of the hydrogen tank within the estimated charging time, and
control an operation of the hydrogen compressor to output hydrogen at the target charging pressure.

5. The apparatus of claim 3, wherein the hydrogen charging device is configured to:
charge, via the compression by the hydrogen compressor, the hydrogen tank under the target charging pressure for the estimated charging time, and
determine, based on the pressure of the hydrogen tank being equal to or greater than a preset upper pressure limit of the hydrogen tank, that charging of the hydrogen tank and charging of the battery are completed.

6. The apparatus of claim 1, wherein the processor is configured to:
control, based on charging of the hydrogen tank and charging of the battery being completed, the output device to output the charging information, wherein the charging information comprises charging-completion information.

7. The apparatus of claim 1, wherein the hydrogen charging device is configured to:
determine, based on the pressure of the hydrogen tank being less than a preset upper pressure limit of the hydrogen tank, whether a temperature of the hydrogen tank exceeds a preset upper temperature limit of the hydrogen tank.

8. The apparatus of claim 7, wherein the hydrogen charging device is configured to:
based on a determination that the temperature of the hydrogen tank exceeds the preset upper temperature limit, stop charging the hydrogen tank and wait before resuming the charging of the hydrogen tank until the temperature of the hydrogen tank drops to a threshold temperature, wherein the threshold temperature is set based on an external temperature of the vehicle.

9. The apparatus of claim 1, wherein the hydrogen charging device is configured to:
based on the pressure of the hydrogen tank being less than or equal to the supply pressure, supply, via a hydrogen charging port of the vehicle, the first portion of hydrogen received from the hydrogen supply device, wherein the first portion of hydrogen bypasses the hydrogen compressor.

10. The apparatus of claim 9, wherein the hydrogen charging device is configured to:
based on a temperature of the hydrogen tank exceeding a preset upper temperature limit of the hydrogen tank during the charging of the first portion of hydrogen or based on the pressure of the hydrogen tank exceeding the supply pressure, terminate a charging process that bypasses the hydrogen compressor.

11. A method for controlling charging of a vehicle, the method comprising:
charging, by an electricity charging device, a battery of the vehicle;
supplying, by a hydrogen charging device, a first portion of hydrogen received from a hydrogen supply device into a hydrogen tank of the vehicle to charge the hydrogen tank under supply pressure of the hydrogen supply device;
based on pressure of the hydrogen tank exceeding the supply pressure of the hydrogen supply device, compressing, using a hydrogen compressor, a second portion of hydrogen received from the hydrogen supply device;
supplying the compressed second portion of hydrogen into the hydrogen tank to charge the hydrogen tank;
receiving charging information from the electricity charging device and the hydrogen charging device; and
outputting, through an output device, the charging information.

12. The method of claim 11, further comprising:
receiving the charging information, wherein the charging information comprises an estimated charging time for fully charging the battery by the electricity charging device.

13. The method of claim 11, further comprising:
based on an estimated charging time for fully charging the battery and the pressure of the hydrogen tank exceeding the supply pressure of the hydrogen supply device, determining target charging pressure for the hydrogen compressor, and
charging the hydrogen tank under the target charging pressure.

14. The method of claim 13, further comprising:
determining, by the hydrogen charging device, the target charging pressure such that the hydrogen tank is charged to a preset upper pressure limit of the hydrogen tank within the estimated charging time; and
controlling an operation of the hydrogen compressor to output the target charging pressure.

15. The method of claim 13, further comprising:
charging, via the compression by the hydrogen compressor, the hydrogen tank under the target charging pressure for the estimated charging time; and
determining, based on the pressure of the hydrogen tank being equal to or greater than a preset upper pressure limit of the hydrogen tank, that charging of the hydrogen tank and charging of the battery are completed.

16. The method of claim 11, further comprising:
controlling, based on charging of the hydrogen tank and charging of the battery being completed, the output device to output the charging information, wherein the charging information comprises charging-completion information.

17. The method of claim 11, further comprising:
determining, based on the pressure of the hydrogen tank being less than a preset upper pressure limit of the hydrogen tank, whether a temperature of the hydrogen tank exceeds a preset upper temperature limit of the hydrogen tank.

18. The method of claim 17, further comprising:
based on a determination that the temperature of the hydrogen tank exceeds the preset upper temperature limit, stopping charging the hydrogen tank and waiting before resuming the charging of the hydrogen tank until the temperature of the hydrogen tank drops to a threshold temperature, wherein the threshold temperature is set based on an external temperature of the vehicle.

19. The method of claim 11, further comprising:
based on the pressure of the hydrogen tank being less than or equal to the supply pressure, supplying, via a hydrogen charging port of the vehicle, the first portion of hydrogen received from the hydrogen supply device, wherein the first portion of hydrogen bypasses the hydrogen compressor.

20. An apparatus for controlling charging of a vehicle, the apparatus comprising:
an electricity charging device configured to charge a battery of the vehicle;
a hydrogen charging device configured to supply hydrogen received from a hydrogen supply device into a hydrogen tank of the vehicle to charge the hydrogen tank under supply pressure of the hydrogen supply device; and
a processor configured to:
control the electricity charging device to charge the battery; and
control the hydrogen charging device to charge the hydrogen tank until pressure of the hydrogen tank does not exceed the supply pressure of the hydrogen supply device.
